(19) United States
(12) Patent Application Publication
(10) Pub. No.: US 2006/0207237 A1
(43) Pub. Date: Sep. 21, 2006

(54) Method of handling ergonomic rake

(75) Inventors: Paul A. Iaizzo, White Bear Lake, MN (US); Scott D. Augustine, Bloomington, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Augustine Biomedical and Design LLC

(21) Appl. No.: 11/368,181

(22) Filed: Mar. 3, 2006

Related U.S. Application Data
(60) Provisional application No. 60/658,077, filed on Mar. 3, 2005.

(51) Int. Cl. A01D 7/00

(52) U.S. Cl. 56/400.12

(57) ABSTRACT

A method for an operator to handle a rake includes gripping, with a first hand, a handle of the rake in proximity to a mid-shaft portion of the handle, and gripping, with a second hand, the handle of the rake in close proximity to a free end of the handle such that a line extending across the row of teeth, being approximately perpendicular to the extension of a centrally located tooth of the row of teeth, forms an angle of less than ninety degrees with portions of the handle, the angle being on a first lateral side of the rake head that is adjacent to the operator.

### RELATED APPLICATION

The present application claims priority to provisional application Ser. No. U.S. 60/658,077, and hereby incorporates said application, in its entirety, herein. The present application is related to an application entitled “Ergonomic Rake,” assigned Attorney Docket No. 49278.2.2, and filed concurrently herewith.

### TECHNICAL FIELD

The present invention relates to methods of handling ergonomic rakes.

### BACKGROUND

Rakes have been a standard tool for the clean-up of leaves and debris for centuries and have changed very little over these many years. The basic design still consists of a row of teeth or tines attached to a rake head and a handle attached to an opposite side of the rake head from the teeth and extending substantially perpendicular to a line extending across the row of teeth.

The biomechanics of raking have remained substantially unchanged over time, the power of the raking motion being produced predominantly by the arms of an operator while the operator's body remains relatively erect and non-twisting. The resultant stroke is inefficient and tiring for the arms. Thus, there is a need for an ergonomic rake design enabling a more efficient ergonomic stroke.

### BRIEF SUMMARY

Methods for handling rakes according to the present invention include gripping, with a first hand, the handle of the rake in proximity to a mid-shaft portion of the handle, and gripping, with a second hand, the handle of the rake in close proximity to a free end of the handle such that the angle of the rake is on a lateral side of the rake head that is adjacent to the operator.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1 is a front elevation view of an exemplary prior art rake.

FIGS. 2 and 3 are schematics of an operator handling the rake of FIG. 1.

FIG. 4 is front elevation view of an ergonomic rake according to one embodiment of the present invention.

FIGS. 5-9 are side elevation views of rake heads according alternate embodiments of the present invention.

FIGS. 10-12 are schematics of the operator handling an ergonomic rake embodiment of the present invention, according to one method of the present invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention.

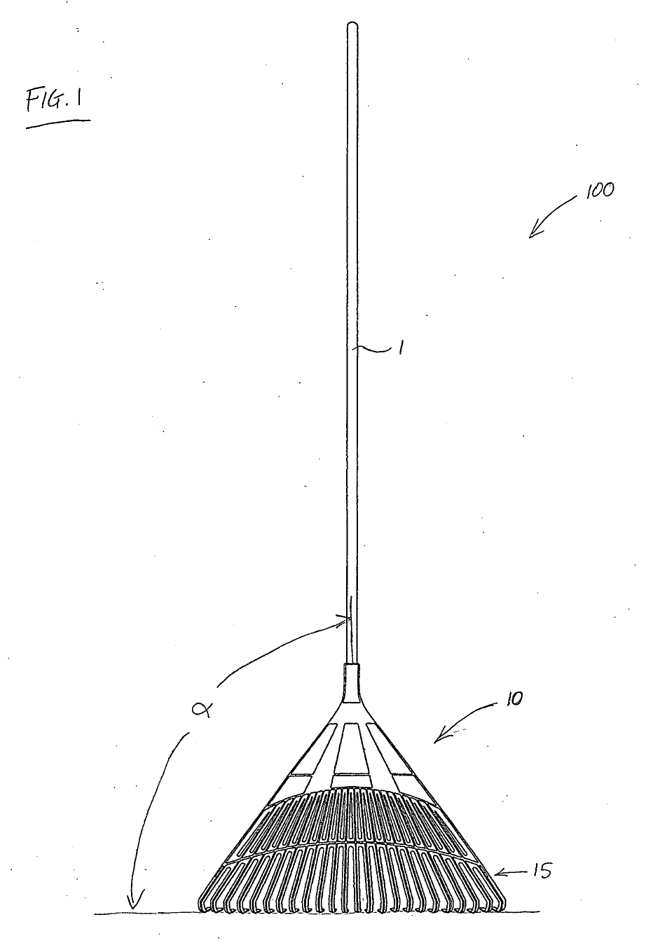

FIG. 1 is a front elevation view of an exemplary prior art rake 100. FIG. 1 shows rake 100 including a handle 1 and a rake head 10 attached thereto; rake head 10 includes a single row of tines or teeth 15 extending distally therefrom. Handle 1 is attached to rake head 10 such that an angle α between handle 1 and a line extending across row of teeth 15 is approximately 90°.

An area of a tip of each tooth of rake 100 is simply the cross section of the tooth at its most distal point and is generally a very small cross sectional area. The small areas comprising the tips of the teeth allow the teeth tips to dig into the ground in order to pull up leaves and other debris. The effective digging into the ground caused by these small cross sectional areas also creates a large amount of resistance to pulling the teeth through the grass. Raking with rake 100 thus requires a large amount of muscle energy to overcome the large resistance created by the relatively sharp teeth tips in the grass.

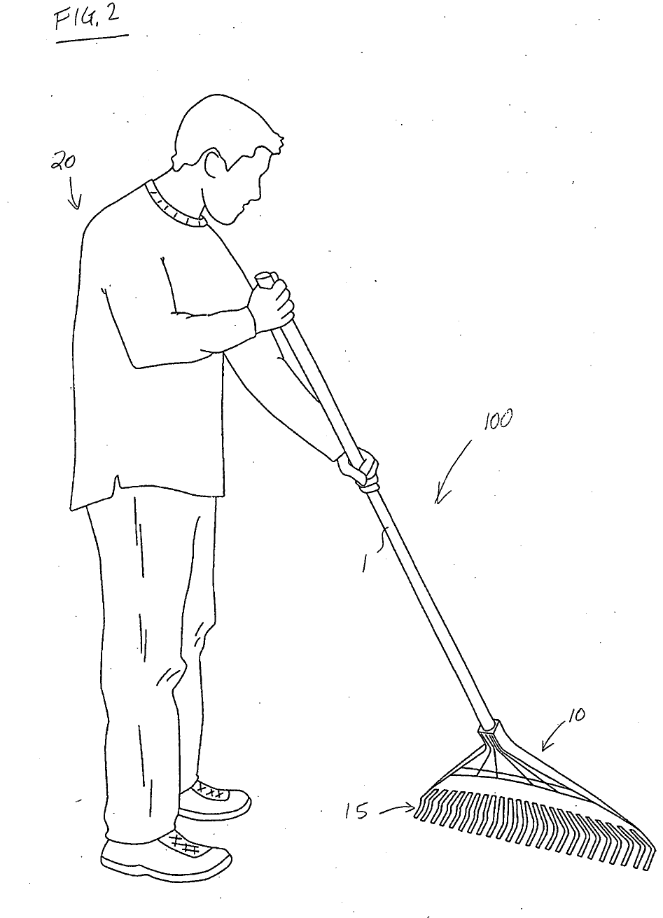

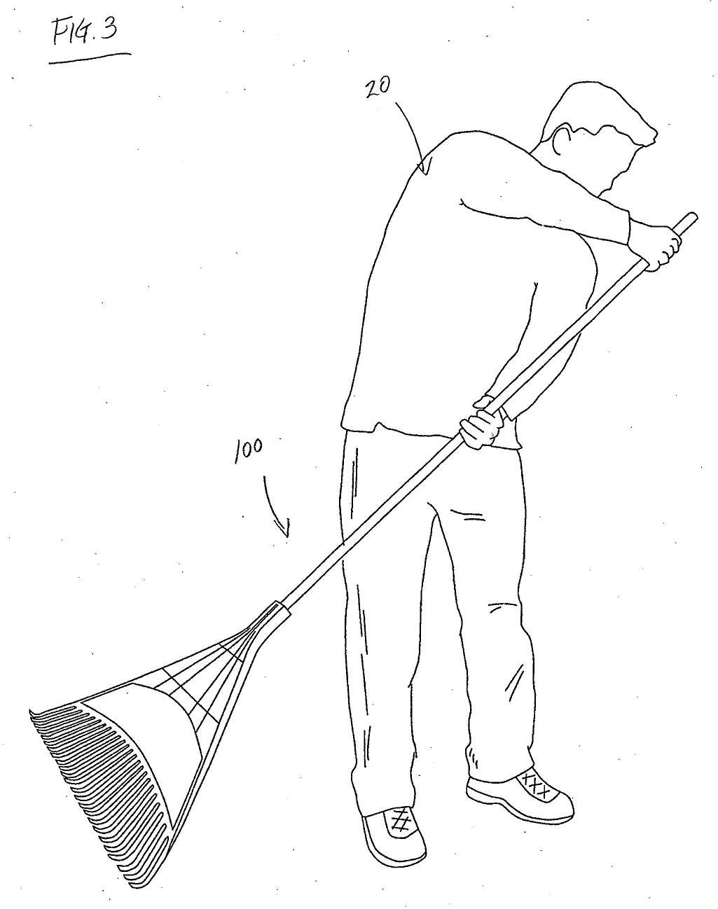

FIGS. 2 and 3 are schematics of an operator 20 handling rake 100. FIG. 2 shows operator 20 standing virtually erect and grasping rake handle 1 in preparation to pull rake head 10 toward or across a front of operator 20 in a stroke accomplished predominantly with a motion of the arms without any advantage from more powerful muscles of the torso. The configuration of rake 100 does not allow a smooth “follow-through” throwing motion, to propel leaves or other debris captured by teeth 15 of rake head 10 away from the operator. FIG. 3 illustrates operator 20 attempting a follow-through motion with rake 100; it can be appreciated from FIG. 3 that such a stroke requires that the arms of operator 20 cross over each other to complete the stroke. The crossing of the arms to complete the raking motion is biomechanically inefficient and the throwing motion requires the operator's back to bend laterally. Repeated lateral bending of the back is an un-natural movement that frequently results in back pain or even back injuries. Thus, a preferred raking motion with a traditional rake, for example rake 100, drags the leaves or debris toward the operator to be deposited near the operator's feet at the end of a half stroke. Leaves that are not thrown may need to be re-raked numerous times before reaching a disposal point.

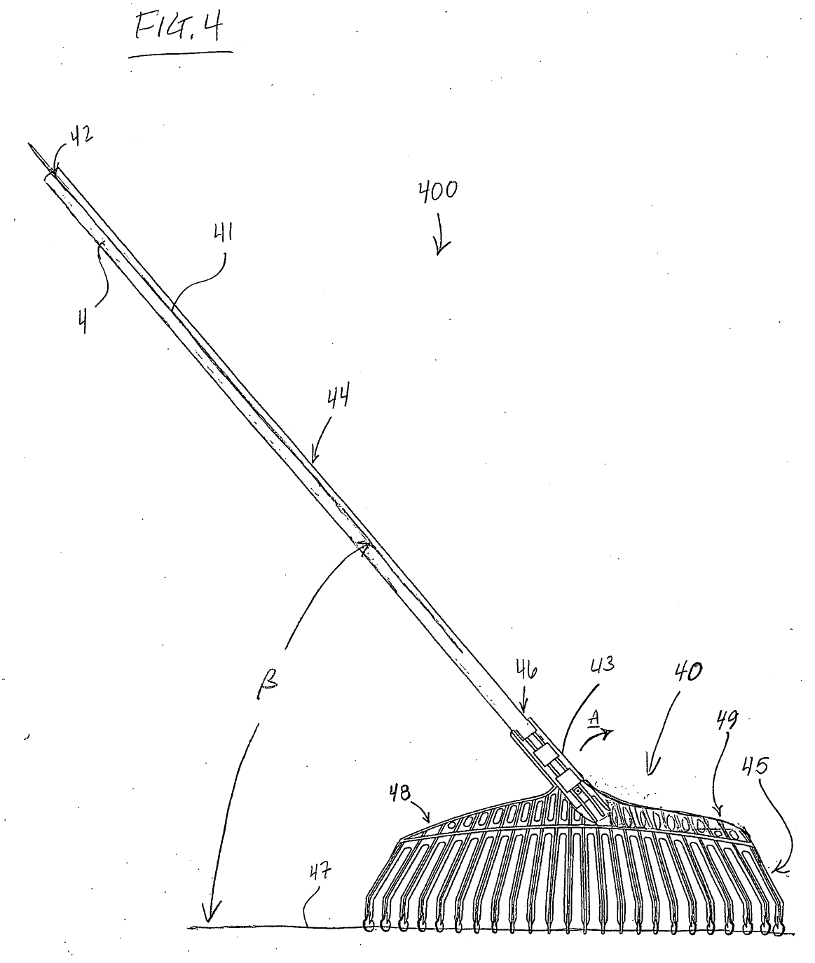

FIG. 4 is front elevation view of an ergonomic rake 400 according to one embodiment of the present invention. FIG. 4 illustrates rake 400 including a handle 4 and a rake head 40; handle 4 extends in a generally straight line 41 from a free end 42 through a mid-shaft portion 44 and includes a coupling end 46 to which head 40 is coupled. It is understood, of course, that non-linear handles may be substituted for the handle 4 in FIG. 4. FIG. 4 further illustrates head 40 including a row of teeth 45, preferably flexible, extending distally therefrom. In certain embodiments, rake head 40 is formed of a molded polymeric material such as plastic, examples of which include, but are not limited to, high density polyethylene and polypropylene. Alternately, rake head 40 may be formed partially or wholly of formed metal such as steel. Handle 4 may be formed from a single piece of hard wood or a laminate of wood veneers; examples of suitable woods include but are not limited to oak, ash, birch or beech. Alternatively, handle 4 may be formed of plastic, fiberglass or aluminum. In some embodiments, a transverse cross-section of handle 4 is generally oval or rectangular, for example like a hockey stick, such that a longer side of the section rests against a palm of a hand that grips the handle according to the methods described below. According to other embodiments, the handle cross-section is generally circular.

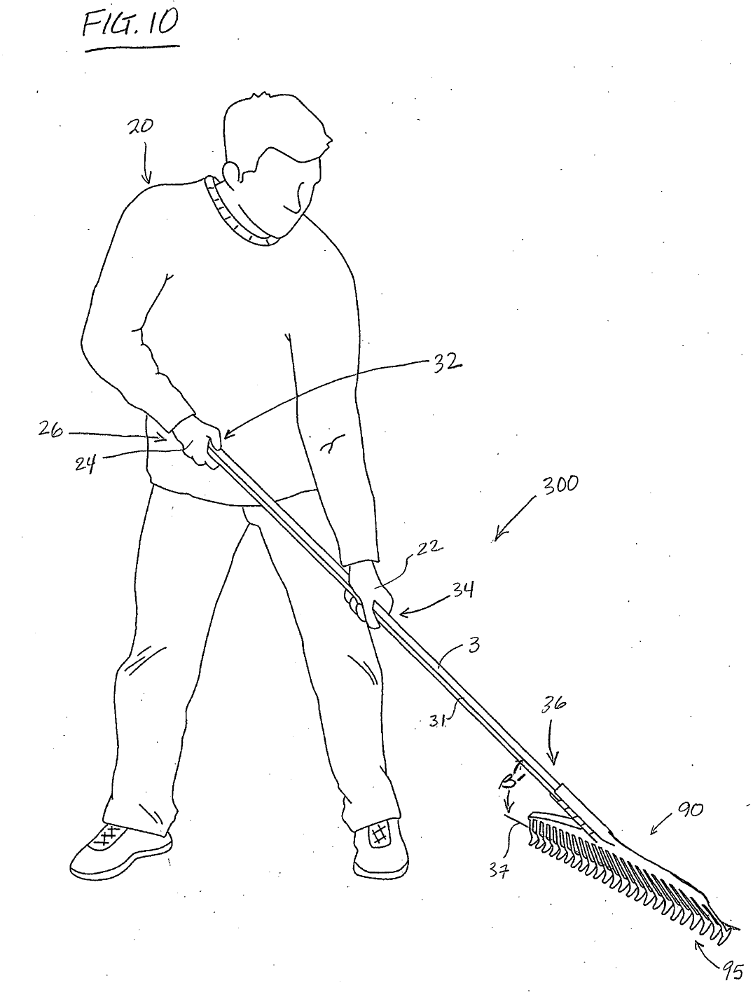

According to embodiments of the present invention handle 4 is coupled to head 40 such that a line extending across the row of teeth 45, i.e. line 47, which is approximately perpendicular to the extension of a centrally located tooth of the row of teeth 45, forms an angle β of less than ninety degrees with line 41 of handle 4. Angle β may be between approximately twenty-five and approximately seventy-five degrees; according to a preferred embodiment, angle β is approximately fifty degrees. Angle β allows an operator, standing in proximity to a first lateral side 48 of rake head 40, to grasp handle 4 like a hockey stick at two gripping locations or segments along the handle and use an efficient sweeping motion to gather leaves and/or other debris, for example as illustrated in FIGS. 10-12. Although FIG. 4 shows handle 4 coupled to rake head 40 in proximity to a midpoint along a width of head 40, in alternate embodiments handle 4 is coupled in proximity to a lateral edge of the rake head 40, for example either toward a first lateral side 48 or toward a second lateral side 49. According to the embodiment illustrated in FIG. 4, rake head 40 further includes an attachment mechanism 43, for coupling head 40 to handle 4; attachment mechanism 43 is angled laterally such that it extends toward first lateral side 48 of head 40, approximately parallel with line 47, to secure head 40 to handle 4 at angle β.

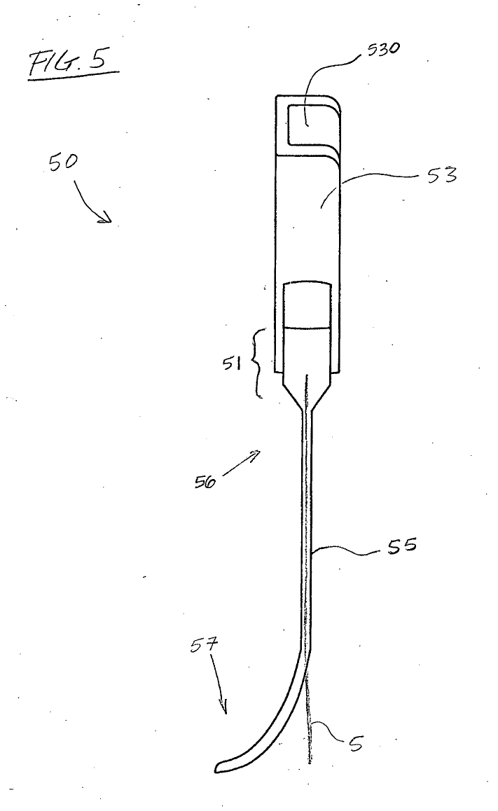

FIGS. 5-9 are side elevation views of various rake heads, according to alternate embodiments of the present invention; each of the various rake heads generally corresponds with rake head 40 illustrated in FIG. 4, in that all include a laterally angled attachment mechanism. It can be seen in FIGS. 5-9 that attachment mechanisms 53, 63, 73, 83 and 93 of rake heads 50, 60, 70, 80 and 90, respectively, each include a groove 530, 630, 730, 830 and 930 into which a coupling end of a handle, for example coupling end 46 of handle 4 shown in FIG. 4, would be fitted, according to some embodiments of the present invention. It is contemplated that any fastening means known to those skilled in the art may be used to secure handle coupling end, i.e. coupling end 46, within grooves 530, 630, 730, 830, 930. Although FIGS. 5-9 illustrate various embodiments of teeth including distal ends angled out of a plane generally defined by the teeth extension, it should be understood that embodiments of the present invention also include rakes and rake heads having straight distal ends extending in the plane of tooth extension, for example, denoted as a line 5 in FIG. 5.

FIG. 5 illustrates attachment mechanism 53 extending from a proximal end 56 of head 50 and a single row of teeth 55 extending distally from proximal end 56. According to the illustrated embodiment, a distal end 57 of each tooth of row of teeth 55 is angled away from a plane generally defined by the extension of teeth 55; vertical line 5 in FIG. 5 denotes the plane, extending into the page. A direction of the angling of teeth distal ends 57 will be denoted as a forward direction corresponding to a direction that head 50 would travel during operation. Referring to FIGS. 4 in conjunction with FIGS. 10-12, it may be appreciated that, rake head 50, including angled teeth distal ends 57, may not be suited for ambidextrous use unless attachment mechanism 53 is coupled to proximal end 56 of head 50 by a pivot joint 51, for example a hinge-type joint. Pivot joint 51 allows a handle, for example handle 4, to pivot from one lateral side of head 50 to the other. For example, referring to FIG. 4, a pivot joint in head 40 would allow handle 4 to pivot, per arrow A, from first lateral side 48 of head 40 to second lateral side 49 so that angle β opens up to be greater than ninety degrees. By way of further example, FIGS. 10-12 show operator 20 gripping a rake handle at first and second gripping segments along the handle for left-handed use, wherein the acute angle (β′) between head and handle is on the lateral side adjacent to the operator; if the rake included rake head 50, teeth distal ends 57 would be oriented forward, toward a right-hand side of operator 20; according to some embodiments of the present invention, a rake including head 50 would allow the handle to pivot, via joint 51, over to the opposite lateral side of the rake head to convert the rake for a right-handed user, who would face operator 20 to rake in the same forward direction or, if standing in the place of operator 20, would rake rearward, or in an opposite direction to that shown in FIGS. 10-12. Handling of inventive rakes for raking, according to methods of the present invention, will be described in greater detail in conjunction with FIGS. 10-12.

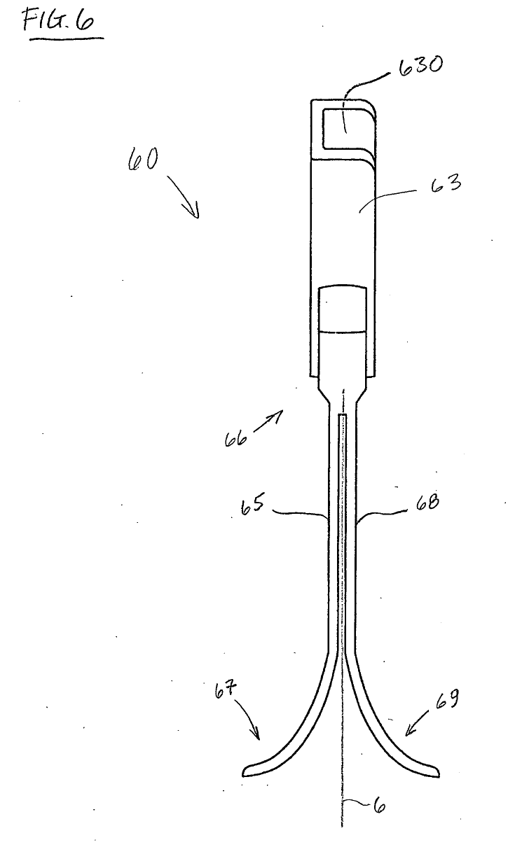

FIG. 6 illustrates rake head 60 including attachment mechanism 63, extending from a proximal end 66 of head 60, and two generally parallel rows of teeth 65 and 68, extending distally from proximal end 66. According to the illustrated embodiment, a distal end 67 of each tooth of row of teeth 65 is angled forward from a plane, denoted by a vertical line 6, generally defined by the distal extension of teeth 65, 68; and a distal end 69 of each tooth of row of teeth 68 is angled rearward from the plane. A pivot joint, for example joint 51 described in conjunction with FIG. 5, is not necessarily included in rake head 60 because of forward and rearward angling teeth distal ends 67, 69 that allow rake to collect leaves and/or other debris when moving in a forward or rearward direction, one direction being suited for left-handed use and the other for right-handed use.

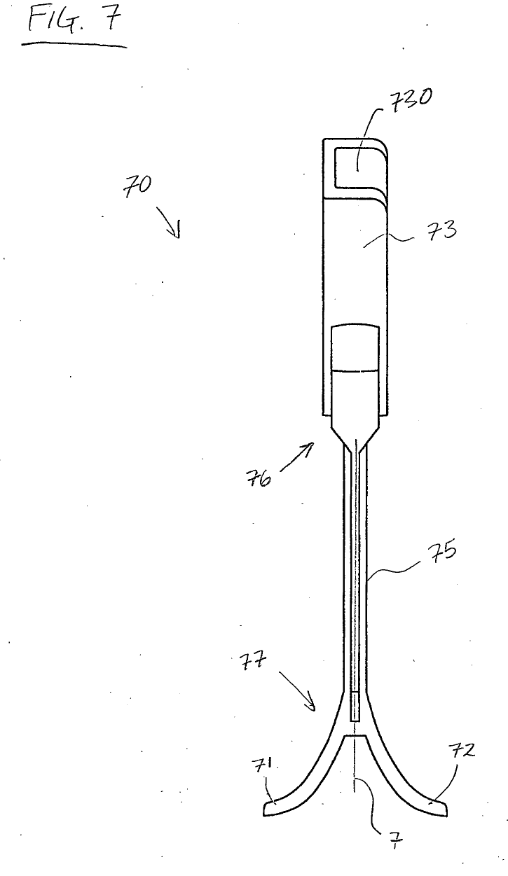

FIG. 7 illustrates rake head 70 including attachment mechanism 73, extending from a proximal end 76 of head 70, and a single row of teeth 75 extending distally from proximal end 76. According to the illustrated embodiment, a distal end portion 77 of each tooth of row of teeth 75 bifurcates into a first set of tips 71 and a second set of tips 72; first set of tips 71 is shown angled forward from a plane, denoted by a vertical line 7, generally defined by the distal extension of teeth 75, and second set of tips 72 is shown angled rearward from the plane. Similar to rake head 60, a pivot joint is not necessarily included in rake head 70.

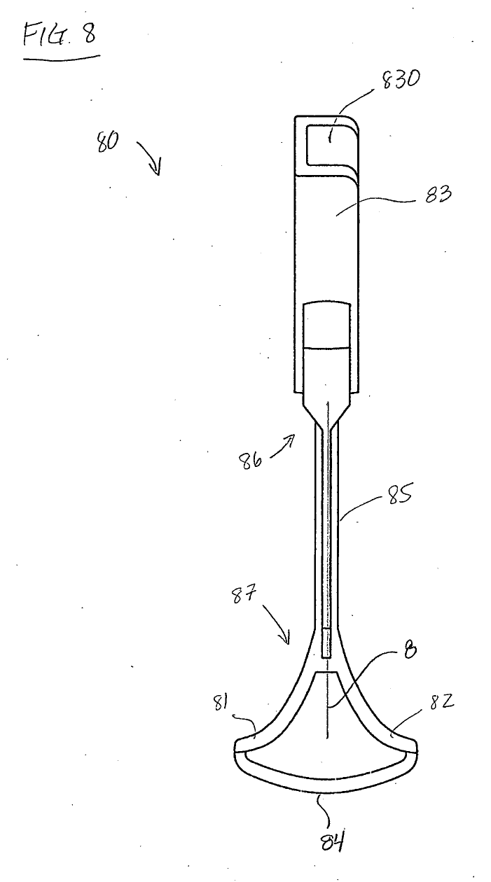

FIG. 8 illustrates rake head 80 including attachment mechanism 83, extending from a proximal end 86 of head 80, and a single row of teeth 85 extending distally from proximal end 86. According to the illustrated embodiment, as with rake head 70 of FIG. 7, a distal end portion 87 of each tooth of row of teeth 85 bifurcates into a first set of tips 81 and a second set of tips 82; first set of tips 81 is shown angled forward from a plane, denoted by a vertical line 8, generally defined by the distal extension of teeth 85, and second set of tips 82 angled rearward from the plane. FIG. 8 further illustrates a skid member 84 extending between tips 81, 82, enclosing open space surrounded by the skid member 84, and tips 81, 82. According to some embodiments of the present invention, the arcuate shape of skid member 84 raises tips 81, 82 above a turf so that tips 81, 82 do not dig into the turf, thus allowing rake head 80 to slide easily over the turf in a mid portion of the raking stroke.

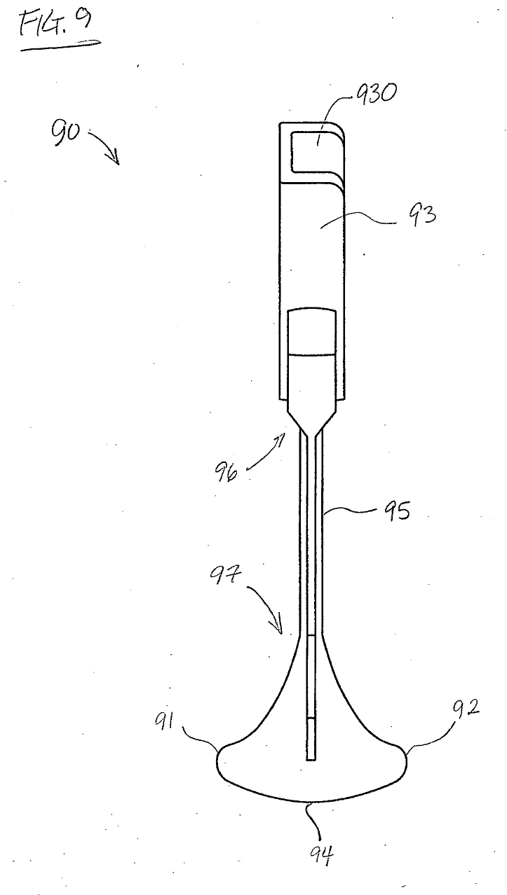

FIG. 9 illustrates rake head 90 including attachment mechanism 93, extending from a proximal end 96 of head 90, and a single row of teeth 95 extending distally from proximal end 96. According to the illustrated embodiment, each tooth of row of teeth 95 includes a distal end portion 97 terminated in a convex distal side 94 that connects a rounded forward corner 91 of each tooth to a rounded rearward corner 92 of each tooth. A generally triangular-shaped piece of solid material forming each distal portion 97 may allow for efficient molding of plastic teeth 95, according to some embodiments. Rounded corners 91, 92 may minimize a resistance when rake head 90 is dragged through grass during a first portion of a raking stroke. Convex distal side 94 forms a skid which may further reduce the resistance when rake head 90 is dragged through the grass or turf at a mid portion of the raking stroke, as previously described for rake head 80 in conjunction with FIG. 8. FIG. 9 further illustrates forward and rearward sides of each distal portion 97, which extend distally to corners 91 and 92, respectively, being concave to create a hook-like shape that may further improve raking efficiency. Similar to heads 60, 70 and 80, head 90 allows forward and rearward raking motions for ambidextrous use without a need for a pivot joint, i.e. joint 51 described in conjunction with FIG. 5.

FIGS. 10-12 are schematics of operator 20 handling an inventive rake 300 according to one method of the present invention. FIGS. 10-12 illustrate rake 300 including a handle 3 and rake head 90; handle 3 extends in a generally straight line 31 from a free end 32 through a mid-shaft portion 34 and includes a coupling end 36 to which head 90 is coupled. According to embodiments of the present invention handle 3 is coupled to head 90 such that a line extending across the row of teeth 95, i.e. line 37, which is approximately perpendicular to the extension of a centrally located tooth of row of teeth 95, forms an angle β′ of less than ninety degrees with line 31 of handle 3. As previously described for angle β of rake 400 in FIG. 4, angle β′ may be between approximately twenty-five and approximately seventy-five degrees; and, according to a preferred embodiment, angle β′ is approximately fifty degrees.

FIGS. 10 illustrates operator 20 holding rake 300 like a hockey stick; a first or left hand 22 of operator 20 grips handle 3 in proximity to mid-shaft portion 34 at a first gripping location or segment (within the operator's left hand) and a second or right hand 24 of operator 20 grips handle 3 in close proximity to free end 32 at a second gripping location or segment (within the operator's right hand). Since handle 3 is generally linear, line 31 extends through both first and second gripping segments, forming an angle β′ between the first or second gripping segments and line 37 of less than ninety degrees. It is contemplated that handle 3 may also be non-linear and still provide the biomechanical advantages described herein. According to these embodiments that have a non-linear handle, portions of the handle corresponding to the first and second gripping segments will still include longitudinal axes forming an angle of less than ninety degrees with line 37.

FIG. 10 further illustrates thumbs of both hands 22, 24 extended generally toward rake head 90 and free end 32 of handle 3 held relatively close to an abdominal area 26 of operator 20 to maximize arm leverage for the start of a raking stroke. FIG. 10 also shows a corresponding arm of hand 24 extending approximately co-linear with line 37.

According to the illustrated method, operator 20 engages a ground surface with row of teeth 95 of rake head 90 to begin the raking stroke, preparing to drag row of teeth 95 across a front of his body from a left-hand (first-hand) side to a right-hand (second-hand) side.

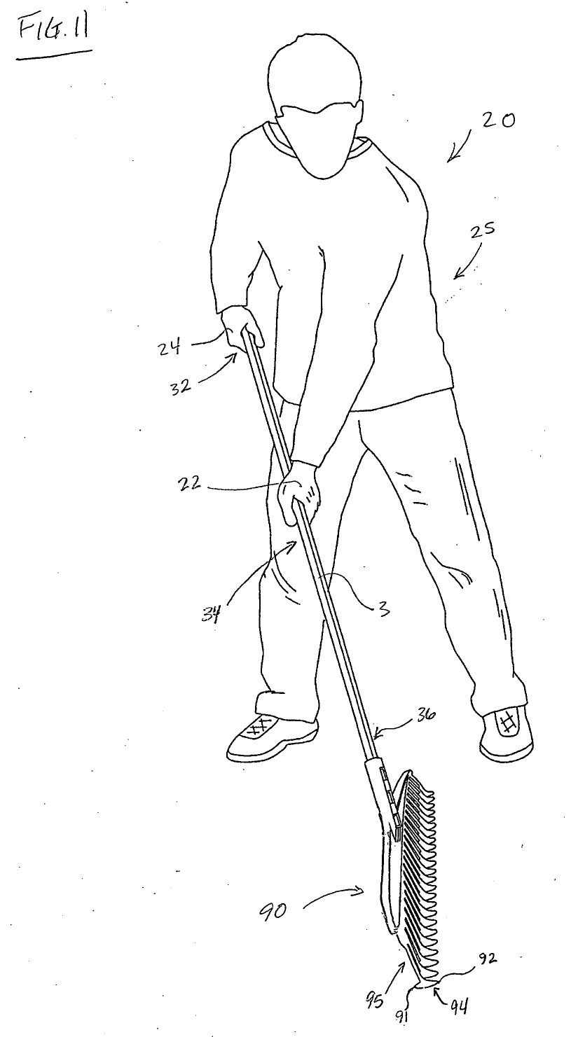

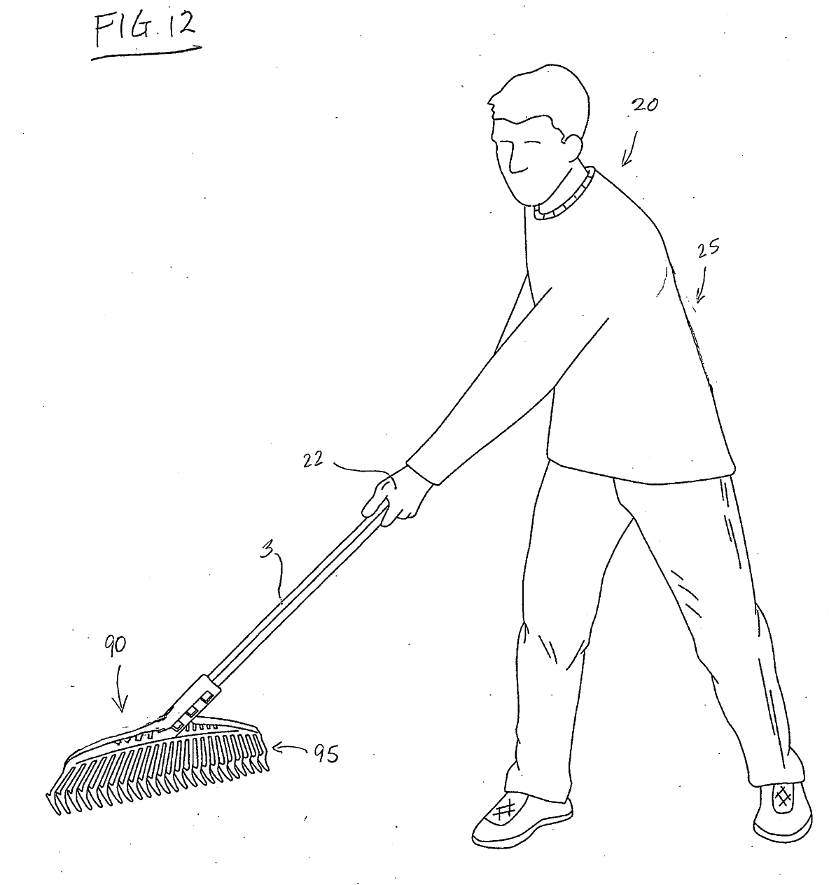

FIG. 11 illustrates a mid-portion of the raking stroke wherein skids 94 of teeth 95 are sliding along the ground; as previously described, skids 94 may reduce resistance of sliding by elevating corners 91, 92 so that corners 91, 92 do not dig into the ground. This reduced resistance allows rake head 90 to accelerate into a follow-through motion of the arms, shown in FIG. 12, to complete the raking stroke that throws leaves and/or other debris beyond the right-hand side of operator 20 so that the need for re-raking may be minimized. It should be noted that alternate embodiments of the present invention include those in which teeth 95, as described in conjunction with FIG. 9, are incorporated in a traditional rake head, for example, replacing teeth 15 rake head 10 of FIG. 1; such a configuration may, at minimum, reduce resistance in dragging head 10 along the ground.

The biomechanics of raking methods associated with embodiments of the present invention may be appreciated with reference to FIGS. 10-12. As shown in these figures, the arms of operator 20 are held relatively stiffly through the mid-portion of the raking stroke while power is generated by a twisting or rotation of a torso 25 of operator 20, and then the follow-through motion of the arms completes the stroke. Using the powerful torso muscles to rake avoids the type of arm fatigue associated with prior art raking, as previously described in conjunction with FIGS. 1 and 2, and the motion achieved may be likened to shooting a hockey puck, batting a baseball or throwing a football. The use of the powerful trunk muscles is routine in athletics because it maximizes power while minimizing the stress on the back and joints.

In the foregoing detailed description, the invention has been described with reference to specific embodiments. However, it may be appreciated that various modifications and changes can be made without departing from the scope of the invention as set forth in the appended claims.

1. A method for a human operator to handle a rake for raking, the method comprising:
gripping, with a first hand and a second hand along a mid-shaft portion of a handle of the rake, such that the second hand is in close proximity to a free end of the handle, the handle extending in a generally straight line from the free end through the mid-shaft portion;
engaging a ground surface with a row of teeth extending distally from a rake head, the rake head coupled to a coupling end of the rake handle such that a line extending across the row of teeth, being approximately perpendicular to the extension of a centrally located tooth of the row of teeth, forms an angle of less than ninety degrees with the generally straight line of the handle, the angle being on a first lateral side of the rake head that is adjacent to the operator.

2. The method of claim 1, wherein engaging the ground surface is performed while the second hand of the operator holds the free end of the rake handle in close proximity to an abdominal area of the operator.

3. The method of claim 1, further comprising dragging the row of teeth across the ground surface by rotating a torso of the operator, while continuing to grip the rake handle with the first and second hand

4. The method of claim 3, wherein the row of teeth accelerate across the ground surface as the torso is rotated.

5. The method of claim 1, further comprising moving the handle from a first-hand side of the operator in a direction toward a second-hand side of the operator to drag the row of teeth across the ground surface while continuing to grip the rake handle with the first and second hand.

6. The method of claim 5, wherein the row of teeth accelerate across the ground surface as the handle is moved.

7. The method of claim 5, further comprising throwing debris past the second-hand side of the operator, the debris collected by the row of teeth dragging across the ground surface.

8. The method of claim 1, further comprising pivoting the handle to a second lateral side of the rake head so that the angle becomes greater than ninety degrees.

9. A method for a human operator to handle a rake for raking, the method comprising:
gripping, with a first hand such that a thumb of the first hand extends toward a head of the rake, a handle of the rake in proximity to a mid-shaft portion of the handle, and gripping, with a second hand such that a thumb of the second hand extends toward the rake head, the handle in close proximity to a free end of the handle;
engaging a ground surface with a row of teeth extending from the rake head, the row of teeth including a first outermost tooth disposed at a first lateral side of the rake head and a second outermost tooth disposed at a second lateral side of the rake head, the first outermost tooth having a length approximately equal to that of the second outermost tooth.

10. The method of claim 9, wherein engaging the ground surface is performed while the second hand of the operator holds the free end of the rake handle in close proximity to an abdominal area of the operator.

11. The method of claim 9, further comprising dragging the row of teeth across the ground surface by rotating a torso of the operator, while continuing to grip the rake handle with the first and second hand

12. The method of claim 11, wherein the row of teeth accelerate across the ground surface as the torso is rotated.

13. The method of claim 9, further comprising moving the handle from a first-hand side of the operator in a direction toward a second-hand side of the operator to drag the row of teeth across the ground surface while continuing to grip the rake handle with the first and second hand.

14. The method of claim 13, wherein the row of teeth accelerate across the ground surface as the handle is moved.

15. The method of claim 13, further comprising throwing debris past the second-hand side of the operator, the debris collected by the row of teeth dragging across the ground surface.

16. The method of claim 9, further comprising pivoting the handle to a second lateral side of the rake head so that the angle becomes greater than ninety degrees.

17. A method for a human operator to handle a rake for raking, the method comprising:
gripping, with a first hand, a handle of the rake in proximity to a mid-shaft portion of the handle, and gripping, with a second hand, the handle of the rake in close proximity to a free end of the handle, the handle extending in a generally straight line from the free end through the mid-shaft portion and a forearm corresponding to the second hand extending approximately co-linear with the generally straight line;
engaging a ground surface with a row of teeth extending from the rake head, the row of teeth including a first outermost tooth disposed at a first lateral side of the rake head and a second outermost tooth disposed at a second lateral side of the rake head, the first outermost tooth having a length approximately equal to that of the second outermost tooth.
